(19) United States
(12) Patent Application Publication
(10) Pub. No.: US 2015/0334227 A1
(43) Pub. Date: Nov. 19, 2015

(54) Systems and Methods of Single Identity Service Regardless of Network Service Provider

(71) Applicant: COX COMMUNICATIONS, INC., Atlanta, GA (US)

(72) Inventors: Robert Clark Whitten, Kennesaw, GA (US); Compton Wharton, JR., Duluth, GA (US)

(73) Assignee: COX COMMUNICATIONS, INC., Atlanta, GA (US)

(21) Appl. No.: 14/279,840

(22) Filed: May 16, 2014

(51) Int. Cl. H04M 3/42; H04W 4/12; H04W 40/34; H04W 4/16

(52) U.S. Cl. CPC H04M 3/42008; H04W 4/16; H04M 3/42042; H04W 4/12; H04W 40/34

(57) ABSTRACT

The systems and methods of single identity service regardless of service provider disclosed herein provides an application on a calling device that intercepts the digits dialed by the subscriber and provides the digits to a server controlled by the service provider that provides the one-number service. The call is routed to the one-number service provider controlled server instead of directly to the dialed digits. In an example embodiment, once the one-number service provider controlled server has the dialed digit information and the call has been routed to the one-number service provider controlled server, the one-number service provider controlled server originates a call to the destination device and presents the one-number identity to the destination network as the caller ID.

### TECHNICAL FIELD

The present disclosure is generally related to telecommunications and, more particularly, is related to single identity phone services.

### BACKGROUND

Caller ID (caller identification, CID), also called calling line identification (CLID), calling number delivery (CND), calling number identification (CNID) or calling line identification presentation (CLIP), is a telephone service, available in analog and digital phone systems and most voice over Internet Protocol (VoIP) applications, that transmits a caller's number to the called party's telephone equipment during the ringing signal, or when the call is being set up but before the call is answered. Where available, caller ID can also provide a name associated with the calling telephone number. The information made available to the called party may be displayed on a telephone's display, on a separately attached device, or on a personal computer.

Caller ID information typically comprises the caller's telephone number and the caller's name. A modem can pass CLID information to a computer for purposes of call logging or blocking, but this can be problematic as modems in different countries have different systems, causing hardware or software incompatibilities. However, many modems are designed and programmed to handle multiple signaling methods, and can be configured to use the local standard. There are heretofore unaddressed needs with previous solutions.

### SUMMARY

Example embodiments of the present disclosure provide systems of single identity service regardless of network service provider. Briefly described, in architecture, one example embodiment of the system, among others, can be implemented as follows: A system comprising: an application loaded on an originating communication device, the application configured to prevent a call from being placed using the communication network of the service provider of the communication device and to send call information to a server enabled for one-number service, the server configured to connect a communication transmission between the originating communication device and a destination communication device, the server sending one-number service identification information in place of the originating communication device information; and a telco gateway configured to connect the originating communication device and the destination communication device over a public communication network.

Embodiments of the present disclosure can also be viewed as providing methods for single identity service regardless of network service provider. In this regard, one embodiment of such a method, among others, can be broadly summarized by the following steps: receiving a call by a service provider from an originating device with a first number; and connecting the call to a destination device by the service provider such that the call to the destination device shows caller identification information of a second number controlled by the service provider.

### BRIEF DESCRIPTION OF THE DRAWINGS

FIG. 1 is a system diagram of an example embodiment of a system of single identity service regardless of service provider.

FIG. 2 is a flow diagram of an example embodiment of a method of single identity service regardless of service provider.

FIG. 3 is a flow diagram of an example embodiment of a method of single identity service regardless of service provider.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Caller ID may be used by the recipient to avoid answering unwanted incoming calls by the concept of informed consent; however, it also poses problems for personal privacy. Additionally, the possibility of caller ID spoofing may render received information unreliable.

In some countries, the terms caller display, calling line identification presentation (CLIP), call capture, or just calling line identity are used; call display is the predominant marketing name used in Canada (although some customers use the phrase caller ID). The idea of CNID as a service for POTS subscribers originated from automatic number identification (ANI) as a part of toll free number service in the United States.

However, CNID and ANI are not the same thing. ANI was originally a term given to a system that identified a caller placing a long distance call, in a non-electronic central office switch. Previous to this implementation, after dialing the long distance number, the caller would be intercepted by the operator to request their number before the call proceeded. Caller ID is made up of two separate pieces of information: the calling number and the billing (or subscriber) name where available. When a call is made from a given name, this name can be passed on through a number of different methods. For example, the caller's name may be data-filled in the originating switch, in which case it is sent along with the number. More commonly, a database is accessed by the receiving switch, in order to match the number to a name. If the name does not exist, then the city, State, Province, or other designation may be sent. Some of these databases may be shared among several companies, each paying every time a name is “extracted”. It is for this reason that mobile callers appear as WIRELESS CALLER, or the location where the phone number is registered (these vary based on which company owns the block of numbers, not the provider to which a number may have been ported). The displayed caller ID also depends on the equipment originating the call.

If the call originates on a POTS line (a standard loop start line), then caller ID is provided by the service provider's local switch. Since the network does not connect the caller to the destination until the phone is answered, generally the caller ID signal cannot be altered by the caller. Most service providers however, allow the caller to block caller ID presentation through the vertical service code *67.

A call placed behind a private branch exchange (PBX) has more options. In the typical telephony environment, a PBX connects to the local service provider through Primary Rate Interface (PRI) trunks. Generally, although not absolutely, the service provider simply passes whatever calling line ID appears on those PRI access trunks transparently across the Public Switched Telephone Network (PSTN). This opens up the opportunity for the PBX administrator to program whatever number they choose in their external phone number fields.

Some IP phone services (ITSPs, or Internet Telephony Service Providers) support PSTN gateway installations throughout the world. These gateways egress calls to the local calling area, thus avoiding long distance toll charges. ITSPs also allow a local user to have a number located in a “foreign” exchange; the New York caller could have a Los Angeles number, for example. When that user places a call, the calling line ID would be that of a Los Angeles number, although they are actually located in New York. This allows a call return without having to incur long distance calling charges.

A cellphone system issue involves the passing of calling line ID information through the network. Cellphone companies must support interconnecting trunks to a significant number of Wireline and PSTN access carriers. In order to save money, many cellphone carriers do not purchase the North American feature Group D or PRI trunks or SS7 trunks (Signalling System 7) required to pass calling line ID information across the network

In the United States, caller ID information is sent to the called party by the telephone switch as an analog data stream (similar to data passed between two modems), using Bell 202 modulation between the first and second rings, while the telephone unit is still on hook. If the telephone call is answered too quickly after the first ring, caller ID information will not be transmitted to the recipient. Two types of caller ID include number only and name+number. Number-only caller ID is called Single Data Message Format (SDMF), which provides the caller's telephone number, the date and time of the call. Name+number caller ID is called Multiple Data Message Format (MDMF), which, in addition to the information provided by SDMF format, can also provide the directory listed name for the particular number. Caller ID readers which are compatible with MDMF can also read the simpler SDMF format, but an SDMF caller ID reader will not recognize an MDMF data stream, and will act as if there is no caller ID information present, e.g. as if the line is not equipped for caller ID.

Instead of sending the caller ID in between the first and second ring, some systems use a “line reversal” to announce the caller ID, or caller ID signals are simply sent without any announcement. Instead of Bell 202, the European alternative V.23 is sometimes used, (without the 75-baud reverse channel) or the data is sent using DTMF signalling.

In general, CID as transmitted from the origin of the call is only the calling party's full phone number (including area code, and including international access code and country code if it's an international call). The calling party name is added by the consumer's terminating central office if the consumer has subscribed to that service. Calling name delivery is not automatic. An SS7 (or Signalling System 7) TCAP query may be launched by the called party's central office, in order to retrieve the information for Calling Name delivery to the caller ID equipment at the consumer's location, if the caller's name has not already been associated with the calling party's line at the originating central office. Canadian systems using CCS7 automatically (but not in all cases) send the calling name with the call set-up and routing information at the time of the call.

Caller ID spoofing is the practice of causing the telephone network to display a number on the recipient's Caller ID display that is not that of the actual originating station. Many telephone services, such as ISDN PRI based PBX installations, and voice over IP services, permit the caller to configure customized caller ID information. In corporate settings this permits the announcement of switchboard number or customer service numbers. The systems and methods disclosed herein differ from spoofing in that the one-number service is originating/re-routing the call to the destination from the number associated with the caller from a different point in the network.

Currently, when a subscriber subscribes to a one-number service, the one-number service associates multiple destination identities with a single number provided to the subscriber. The single number may be provided by a subscriber to a contact to enable the contact to dial one number, and through an algorithm on the one-number server, reach one or more devices pre-assigned by the subscriber to the one-number identity until the subscriber answers the call or the call is sent to voicemail. However, when the subscriber originates a call to a contact, assuming the subscriber is using a device not controlled by the one-number service provider, the identity of the originating device is presented to the contact rather than the one-number service identity.

The systems and methods of single identity service regardless of service provider disclosed herein solves the problem with an application on the calling device that intercepts the digits dialed by the subscriber and provides the digits to a server controlled by the service provider that provides the one-number service. The digits may, as a non-limiting example, be sent over short messaging service, but possibly over the data network. At the same time the call is routed to the one-number service provider controlled server instead of directly to the dialed digits. In an example embodiment, once the one-number service provider controlled server has the dialed digit information and the call has been routed to the one-number service provider controlled server, the one-number service provider controlled server originates a call to the destination device and presents the one-number identity to the destination network as the caller ID.

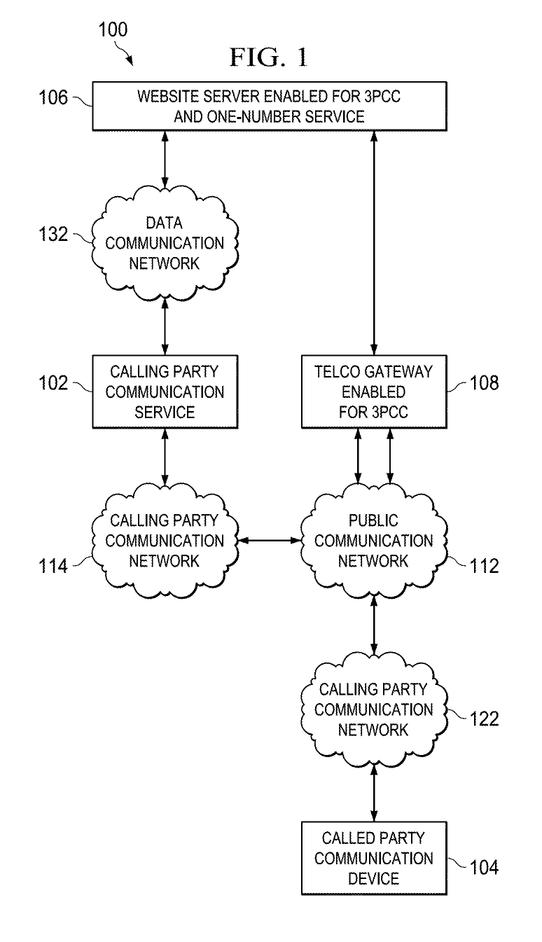

FIG. 1 provides system diagram 100 of an example embodiment of a system of single identity service regardless of the network service provider. A user dials phone number A, which is associated with Called Party Communication Device 104. Calling Party Communication Device 102 contains an application, which intercepts the phone number dialed by the user and places a call to phone number C, which is associated with the one-number service, and the call is passed through device Calling Party Communication Network 114. This call is routed to Public Communication Network (PSTN) 112, which routes the call to Telco Enables Gateway for 3PCC 108. Substantially simultaneously, when the call is placed, a signal containing the calling number of the originating device phone number D and dialed phone number A is sent through Data Communication Network 132 to server 106 which manages the one-number service.

In an example embodiment, server 106 is also enabled for third party call control. When the call is placed from originating device 102 through calling party communication network 114 to public communication network 112, the call is routed to phone number C, which is associated with Telco Gateway 108 and is controlled by the one-number service provider controlled server. Substantially simultaneously, the called party communication device is sent one-number service caller identification associated with the user, phone number B, by server 106 through Telco Gateway 108, which is enabled for third party call control, to public communication network 112 and then on to called party communication device 104 through Calling Party Communication Network 122 associated with destination device 104.

If the user of the destination device wishes to call the originating device, the user of the destination device would enter the one-number service number that he received as caller ID information. When the user hits send, the PSTN routes the call over the data network to the one number service. The user of the destination device thinks he is calling the originating device directly, but it actually goes to server 106 and then is routed to the originating device (or the appropriate device as determined by the one-number service) by the one-number service. Server 106 routes the call from public communication network 112 through gateway 108, for example, a Telco Gateway enabled for 3PCC, which informs server 106 that an incoming call from calling party communication network 122 is routed to the one-number service phone number.

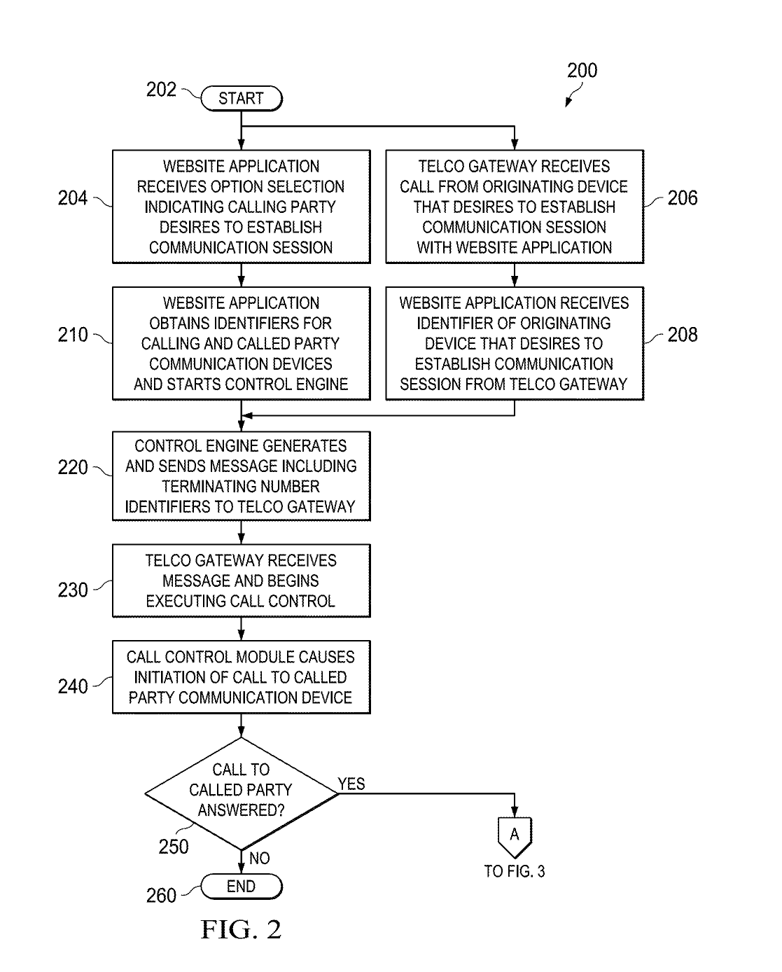

FIG. 2 provides flow diagram 200 of an example embodiment of a method of single identity service regardless of network service provider. The process starts in block 202. In block 204, an application loaded on a user device receives an option selection indicating that a calling party desires to establish a communication session. Although a communication is mainly referred to as a phone call in this disclosure, the communication session may also include an instant message, a text, and a video call, among others. In block 206, a telco gateway receives the call from the originating device that desires to establish a communication session with the application. In block 210, the application obtains identifiers for the calling and the called party communication devices and starts a control engine. In block 208, the application receives the identifier of the originating device that desires to establish the communication session from the telco gateway. In block 220, the control engine generates and sends a message including the terminating number identifiers to the telco gateway.

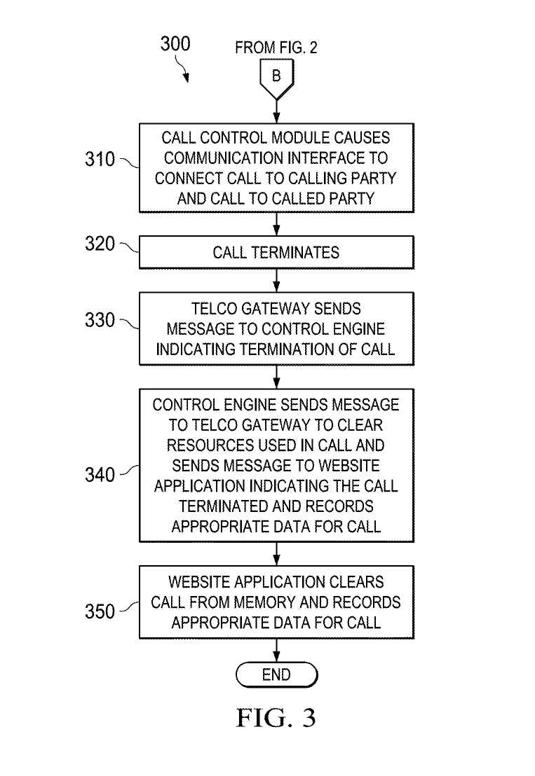

In block 230, the telco gateway receives the message and begins executing call control. In block 240, a call control module causes initiation of a call to the called party communication device. In block 250, a determination is made as to whether the called party answered the call. If the call is not answered, then the method ends in block 260. If the call is answered, then the method continues in FIG. 3.

FIG. 3 provides flow chart 300 of an example embodiment of a method of single identity service regardless of network service provider. In block 310, the call control module causes a communication interface to connect the call to the calling party and to the called party. In block 320, the call terminates. In block 330, the telco gateway sends a message to the control engine indicating the termination of the call. In block 340, the control engine sends a message to the telco gateway to clear resources used in the call and sends a message to the application indicating that the call terminated and records the appropriate data for the call. In block 350, the application clears the call from memory, and records the appropriate data for the call. In an example embodiment, the one-number server saves a mapping of the originating device phone number (phone number D) and called party device (phone number A). That mapping may be stored in memory, which may be cleared after the call is complete. In an alternative embodiment, the mapping is cleared from memory prior to the call being completed.

The flow chart of FIGS. 2 and 3 show the architecture, functionality, and operation of a possible implementation of the single identity service software. In this regard, each block represents a module, segment, or portion of code, which comprises one or more executable instructions for implementing the specified logical function(s). It should also be noted that in some alternative implementations, the functions noted in the blocks may occur out of the order noted in FIGS. 2 and 3. For example, two blocks shown in succession in FIG. 2 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Although the present invention has been described in detail, it should be understood that various changes, substitutions and alterations can be made thereto without departing from the spirit and scope of the invention as defined by the appended claims.

Therefore, at least the following is claimed:

1. A method comprising:
receiving a call by a service provider from an originating device with a first number; and
connecting the call to a destination device by the service provider such that the call to the destination device shows caller identification information of a second number controlled by the service provider.

2. The method of claim 1, wherein the originating device is not controlled by the service provider.

3. The method of claim 1, wherein the originating device subscribes to a one number service with the service provider.

4. The method of claim 1, wherein the first number is blocked from the destination device.

5. The method of claim 1, further comprising receiving by the service provider a call from the destination device to the second number and routing the call to the originating device.

6. The method of claim 1, wherein the call from the originating device to the destination device is interrupted by an application on the originating device and routed to the service provider.

7. The method of claim 6, wherein the application provides the call information to the service provider by at least one of SMS messaging and messaging over a data network.

8. A system comprising:
an application loaded on an originating communication device, the application configured to prevent a call from being placed using the communication network of the service provider of the communication device and to send call information to a server enabled for one-number service, the server configured to connect a communication transmission between the originating communication device and a destination communication device, the server sending one-number service identification information in place of the originating communication device information; and
a telco gateway configured to connect the originating communication device and the destination communication device over a public communication network.

9. The system of claim 8, wherein the originating device is not controlled by the service provider.

10. The system of claim 8, wherein the originating device subscribes to a one-number service with the service provider.

11. The system of claim 8, wherein the first number is blocked from the destination device.

12. The system of claim 8, wherein the server is configured to receive a call from the destination device to the one-number system and to route the call to the originating device.

13. The system of claim 8, wherein the application is configured to provide call information to the server by at least one of SMS messaging and messaging over a data network.

14. A tangible computer readable medium comprising software, the software comprising instructions for performing:
receiving a call by a service provider from an originating device with a first number; and
connecting the call to a destination device by the service provider such that the call to the destination device shows caller identification information of a second number controlled by the service provider.

15. The method of claim 14, wherein the originating device is not controlled by the service provider.

16. The method of claim 14, wherein the originating device subscribes to a one number service with the service provider.

17. The method of claim 14, further comprising instructions for blocking the first number from the destination device.

18. The method of claim 14, further comprising instructions for receiving by the service provider a call from the destination device to the second number and routing the call to the originating device.

19. The method of claim 14, further comprising instructions for interrupting the call from the originating device to the destination device by an application on the originating device and for routing the call to the service provider.

20. The method of claim 19, further comprising instructions for providing the call information by the application to the service provider by at least one of SMS messaging and messaging over a data network.
